(19) United States
(12) Patent Application Publication
(10) Pub. No.: US 2016/0178942 A1
(43) Pub. Date: Jun. 23, 2016

(54) METHOD OF FORMING AN ALIGNMENT LAYER AND METHOD OF MANUFACTURING A DISPLAY PANEL

(71) Applicant: Samsung Display Co., Ltd., Yongin-City (KR)

(72) Inventors: Jae-Hyun LEE, Anyang-si (KR); Kyoung-Hae MIN, Asan-si (KR); Yeon-Ha BAEK, Jinju-si (KR); Ho-Yong SHIN, Suwon-si (KR); Hong-Beom LEE, Hwaseong-si (KR)

(21) Appl. No.: 14/713,173

(22) Filed: May 15, 2015

(30) Foreign Application Priority Data
Dec. 19, 2014 (KR) 10-2014-0184539

(51) Int. Cl. G02F 1/1337

(52) U.S. Cl. CPC G02F 1/1337; G02F 1/133788; G02F 2001/133749

(57) ABSTRACT

In a method of forming an alignment layer, a first substrate, a second substrate opposite to the first substrate and a liquid crystal layer including a reactive mesogen are formed on a stage on which a groove is formed. The liquid crystal layer is disposed between the first and second substrates. An alignment layer is formed by exposing the liquid crystal layer to harden the reactive mesogen. Although the first and second substrates have a curved shape, the pretilt angles of the first and second alignment layers are matched such that a transmittance of the display panel increases and a response time decreases.

### CLAIM OF PRIORITY

This application makes reference to, incorporates the same herein, and claims all benefits accruing under 35 U.S.C. §119 from an application earlier filed in the Korean Intellectual Property Office on 19 Dec. 2014 and there duly assigned Serial No. 10-2014-0184539.

### BACKGROUND OF THE INVENTION

1. Field of the Invention

Example embodiments relate generally to methods of forming an alignment layer, more particularly, to methods of forming an alignment layer including a reactive group and methods of manufacturing a display panel including the alignment layer.

2. Description of the Related Art

A liquid crystal display apparatus is one kind of flat panel displays (“FPD”s), which are used broadly recently. Examples of the FPDs include, but are not limited to, a liquid crystal display (“LCD”), a plasma display panel (“PDP”) and an organic light emitting display (“OLED”).

The LCD apparatus applies voltages to molecules of liquid crystal to adjust arrangements of the molecules thereby changing optical characteristics of a liquid crystal cell such as birefringence, optical activity, dichroism and light scattering to display an image.

The LCD apparatus includes a liquid crystal display panel and a backlight assembly. Because a distance between an observer's eye and a central region of the display panel and a distance between the observer's eye and an edge region of the display panel are different from each other, the observer may feel the difference between the distances. To solve the problem, a display apparatus may have a curved shape.

In order to obtain a uniform brightness and a high contrast ratio, an inserted liquid crystal molecule is aligned in a direction. The display panel includes upper and lower alignment layers to align the liquid crystal molecule, and alignment directions of the upper and lower alignment layers are misaligned by bending the display panel to have the curved shape. Accordingly, a low transmittance and a low response time may occur by the misalignment.

The above information disclosed in this Background section is only for enhancement of understanding of the background of the inventive concept, and, therefore, it may contain information that does not form the prior art that is already known in this country to a person of ordinary skill in the art.

### SUMMARY OF THE INVENTION

Accordingly, the inventive concept is provided to substantially obviate one or more problems due to limitations and disadvantages of the related art.

Some example embodiments provide a method of forming an alignment layer capable of increasing a transmittance.

Some example embodiments provide a method of manufacturing a display panel capable of increasing a transmittance.

According to example embodiments, in a method of forming an alignment layer, a first substrate, a second substrate opposite to the first substrate and a liquid crystal layer including a reactive mesogen are formed on a stage on which a groove is formed. The liquid crystal layer is disposed between the first and second substrates. An alignment layer is formed by exposing the liquid crystal layer to harden the reactive mesogen.

In an example embodiment, in forming the alignment layer, first and second alignment layers may be formed on the first and second substrates, respectively.

In an example embodiment, pretilt angles of the first and second alignment layers may be matched to each other.

In an example embodiment, the reactive mesogen may include a photoreactive group.

In an example embodiment, a vertical pretilt angle of the alignment layer may be within a range of about 1° to about 10°.

In an example embodiment, in forming the alignment layer, the liquid crystal layer may be exposed by using ultraviolet rays.

In an example embodiment, the liquid crystal layer may be radiated by ultraviolet rays with an intensity of about more than 10 J/cm².

In an example embodiment, in forming the alignment layer, the liquid crystal layer in which an electric field is generated may be exposed.

In an example embodiment, the groove may be formed on the stage such that the groove is horizontally symmetrical.

In an example embodiment, the first and second substrates may be disposed along a top surface of the stage.

According to example embodiments, in a method of manufacturing a display panel, a preliminary display panel including a first substrate, a second substrate opposite to the first substrate and a liquid crystal layer including a reactive mesogen are disposed on a stage on which a groove is formed. The liquid crystal layer is disposed between the first and second substrates. An alignment layer is formed by exposing the preliminary display to harden the reactive mesogen. The preliminary display is bended.

In an example embodiment, in forming the alignment layer, first and second alignment layers may be formed on the first and second substrates, respectively.

In an example embodiment, pretilt angles of the first and second alignment layers may be matched to each other.

In an example embodiment, the reactive mesogen may include a photoreactive group.

In an example embodiment, a vertical pretilt angle of the alignment layer may be within a range of about 1° to about 10°.

In an example embodiment, in forming the alignment layer, the liquid crystal layer may be exposed by using ultraviolet rays.

In an example embodiment, the liquid crystal layer may be radiated by ultraviolet rays with an intensity of about more than 10 J/cm².

In an example embodiment, in forming the alignment layer, the liquid crystal layer in which an electric field is generated may be exposed.

In an example embodiment, the display panel may operate in a vertical alignment mode.

In an example embodiment, the groove may be formed on the stage such that the groove is horizontally symmetrical.

According to example embodiments, after the preliminary display panel is disposed on the stage on which a groove is formed, the alignment layer is formed by exposing the liquid crystal layer in which the electric field is generated and hardening the reactive mesogen. Accordingly, pretilt angles of the first and second alignment layers are substantially matched to each other, and a transmittance of the display panel increases.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is a plan view illustrating a display panel according to an example embodiment.

FIGS. 2 and 3 are cross-sectional views illustrating a display panel of FIG. 1 according to an example embodiment.

FIGS. 4A to 4F are cross-sectional views for describing a method of manufacturing a display panel according to an example embodiment.

### DETAILED DESCRIPTION OF THE EMBODIMENTS

Various example embodiments will be described more fully with reference to the accompanying drawings, in which embodiments are shown. This inventive concept may, however, be embodied in many different forms and should not be construed as limited to the embodiments set forth herein. Rather, these embodiments are provided so that this disclosure will be thorough and complete, and will fully convey the scope of the inventive concept to those skilled in the art. Like reference numerals refer to like elements throughout this application.

It will be understood that, although the terms first, second, etc. may be used herein to describe various elements, these elements should not be limited by these terms. These terms are used to distinguish one element from another. For example, a first element could be termed a second element, and, similarly, a second element could be termed a first element, without departing from the scope of the inventive concept. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments and is not intended to be limiting of the inventive concept. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other.

Unless otherwise defined, all terms (including technical and scientific terms) used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

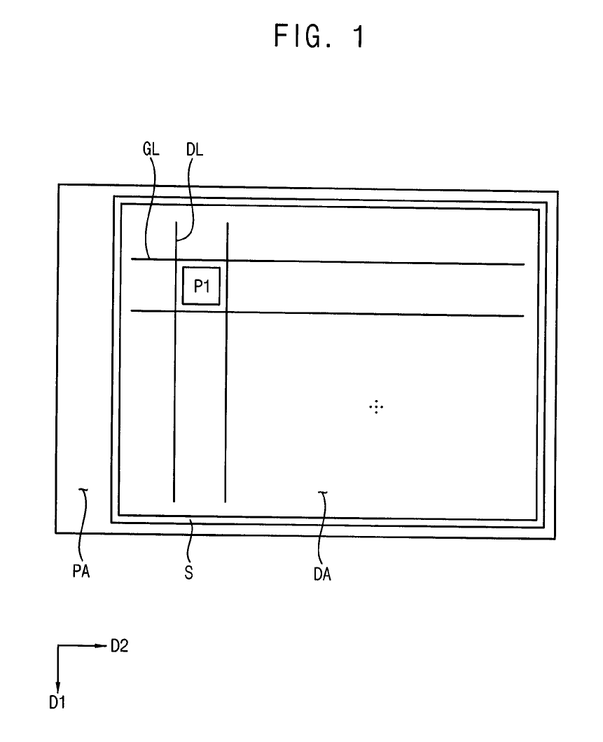

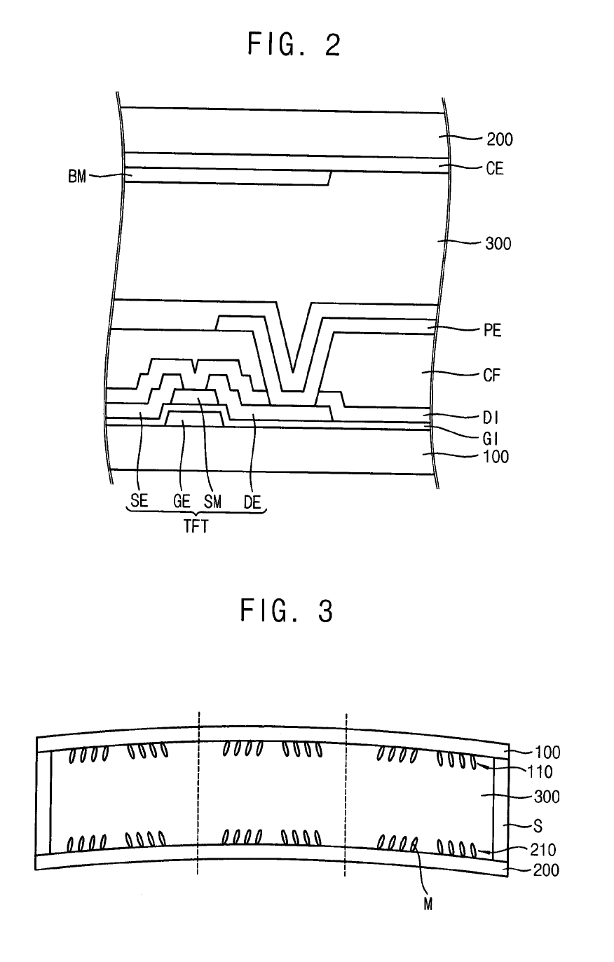

FIG. 1 is a plan view illustrating a display panel according to an example embodiment. FIGS. 2 and 3 are cross-sectional views illustrating a display panel of FIG. 1 according to an example embodiment.

In reference to FIGS. 1 to 3, a display panel may include a display area DA and a peripheral area PA surrounding the display area DA, and the display panel may further include a sealing member S corresponding to a boundary of the display area DA and the peripheral area PA.

The display panel includes a plurality of gate lines GL, a plurality of data lines DL and a plurality of pixels.

The plurality of gate lines may extend in a first direction Dl. The plurality of data lines may extend in a second direction D2 crossing (e.g., substantially perpendicular to) the first direction D1. Alternatively, although not illustrated in FIG. 1, the plurality of gate lines may extend in the second direction D2, and the plurality of data lines may extend in the first direction D1.

The plurality of pixels may be arranged in a matrix form. The plurality of pixels may be disposed in a plurality of pixel areas that are defined by the plurality of gate lines GL and the plurality of data lines DL.

Each pixel may be connected to a respective one of the gate lines (e.g., an adjacent one gate line) and a respective one of the data lines (e.g., an adjacent one data line).

Each pixel may have, but are not limited to, a rectangular shape. Alternatively, each pixel may have a V shape, a Z shape, etc.

Each pixel may include, but are not limited to, three sub-pixels for displaying red, blue and green colors. For convenience of explanation, only one pixel including three sub-pixels is illustrated in FIG. 3.

The display panel includes a first substrate 100, a second substrate 200 and a liquid crystal layer 300.

A gate insulation layer GI, a data insulation layer DI, a thin film transistor TFT, a color filter CF and a pixel electrode PE may be disposed on the first substrate 100.

The first substrate 100 may be a transparent substrate. For example, the first substrate 100 may be a glass substrate or a transparent plastic substrate. The first substrate 100 may include the plurality of pixel areas for displaying an image. The plurality of pixel areas may be arranged in a matrix form having a plurality of columns and a plurality of rows. The pixel areas may be defined by the gate lines and the data lines.

Because a distance between an observer's eye and a central region of a conventional display panel and a distance between the observer's eye and an edge region of the conventional display panel are different from each other, the observer may feel the difference between the distances. To reduce the difference between the distances, the first substrate 100 may have a curved shape.

A switching element may be disposed on the first substrate 100. For example, the switching element may be the thin film transistor TFT. The switching element may be connected to the respective one of the gate lines (e.g., the adjacent one gate line) and the respective one of the data lines (e.g., the adjacent one data line). For example, the switching element may be disposed at an area at which the respective one of the gate lines and the respective one of the data lines cross each other. The thin film transistor TFT may be disposed on the first substrate 100.

A gate pattern including the gate electrode GE and the gate line GL may be disposed on the first substrate 100. The gate line GL may be electrically connected to the gate electrode GE.

The gate insulation layer GI may be disposed on the first substrate 100 on which the gate pattern is disposed such that the gate pattern is insulated.

The gate insulation layer GI may include inorganic insulation material. For example, the gate insulation layer GI may include silicon oxide (SiOₓ) or silicon nitride (SiNₓ).

A semiconductor pattern SM may be disposed on the gate insulation layer GI. The semiconductor pattern SM may overlap the gate electrode GE.

A data pattern may be disposed on the gate insulation layer GI on which the semiconductor pattern SM including the data line DL and a source electrode SE is disposed. The source electrode SE may partially overlap the semiconductor pattern SM. The source electrode SE may be electrically connected to the data line DL.

The drain electrode DE may be spaced apart from the source electrode SE on the semiconductor pattern SM. The semiconductor pattern SM may have a conductive channel between the source electrode SE and the drain electrode DE.

For example, the thin film transistor TFT may include the gate electrode GE, the source electrode SE, the drain electrode DE and the semiconductor pattern SM.

The color filter CF may be disposed on the first substrate 100 to provide a color to an incident light.

The color filter CF may be disposed between the data lines DL which are adjacent to each other. The color filter CF may provide a color to the light transmitting the liquid crystal layer 300.

The color filter CF may be provided to correspond to each pixel area. A plurality of color filters CF may be disposed on the first substrate 100. The color filters CF may include a red color filter, green color filter and a blue color filter. The color filters CF, which are adjacent to each other, may have different colors from each other between pixel areas adjacent to each other.

The color filters CF may be formed to be spaced apart from a border between the pixel areas adjacent to each other in the first direction D1 and in the second direction D2 crossing the first direction D1. The color filters CF may be formed in an island-shape with borders which are the gate lines GL and data lines DL in the first and second directions D1 and D2. Alternatively, the color filters CF may be overlapped on a border between the pixel areas adjacent to each other.

In addition, the color filters CF may include a photosensitive organic material.

The pixel electrode PE may be disposed on the pixel area. The pixel electrode PE may be disposed on the color filter CF. The pixel electrode PE may be electrically connected to the drain electrode DE of the thin film transistor TFT through a contact hole CH. Accordingly, the grayscale voltage may be applied to the pixel electrode PE through the thin film transistor TFT.

For example, the pixel electrode PE may include at least one transparent conductive material selected from the group consisting of indium tin oxide (ITO), indium zinc oxide (IZO) and aluminum zinc oxide (AZO).

For example, the pixel electrode PE may have a slit pattern.

The pixel electrode PE and the common electrode CE on the second substrate 200 which is described later may generate an electric field in the liquid crystal layer 300.

The second substrate 200 may be a transparent substrate. For example, the second substrate 200 may be a glass substrate or a transparent plastic substrate.

Because a distance between an observer's eye and a central region of a conventional display panel and a distance between the observer's eye and an edge region of the conventional display panel are different from each other, the observer may feel the difference between the distances. To reduce the difference between the distances, the second substrate 200 may have a curved shape.

For example, the second substrate 200 may have a curved shape corresponding to the curved shaped of the first substrate 100.

The common electrode CE and a black matrix BM may be disposed on the second substrate 200.

The common electrode CE may be disposed on the second substrate 200. The common electrode CE may be disposed on an entire surface of the second substrate 200.

For example, the common electrode CE may include at least one transparent conductive material selected from the group consisting of indium tin oxide (ITO), indium zinc oxide (IZO) and aluminum zinc oxide (AZO).

A common voltage may be applied to the common electrode CE. The common electrode CE and the pixel electrode PE on the first substrate 100 may generate the electric field in the liquid crystal layer 300.

The black matrix BM may overlap the data line DL extending in the second direction D2 to block light. For example, the black matrix BM may be disposed on a border between the pixel areas adjacent to each other.

For example, the black matrix BM may be disposed to correspond to the gate line GL and the thin film transistor TFT. The black matrix BM may overlap the gate line GL extending in the first direction D1 to block light. For example, the black matrix BM may be formed to correspond to a non-display area of a pixel.

For example, the black matrix BM may be formed to include black material including photosensitivity organic material. For example, the black matrix BM may include stain such as carbon black, organic/inorganic pigment, color (R, G and B) mix pigment, etc. to display black color.

The liquid crystal layer 300 may be disposed between the first and second substrates 100 and 200.

The liquid crystal layer 300 may include liquid crystal molecules. An electric field may be generated by voltages applied to the pixel electrode and the common electrode. By adjusting an intensity of the electric field and an arrangement of the liquid crystal molecules, transmittance of light passing through the liquid crystal layer 300 may be adjusted such that a desired image may be displayed.

The display panel may include an alignment layer to align the liquid crystal molecules of the liquid crystal layer 300. The alignment layer may pre-tilt the liquid crystal molecules of the liquid crystal layer 300.

The alignment layer may include a mesogen M which is provided by hardening a reactive mesogen in the liquid crystal layer 300. The mesogen M may align the liquid crystal molecules of the liquid crystal layer 300.

For example the reactive mesogen may include a photoreactive group.

In an example embodiment, the display panel may include first and second alignment layers 110 and 210. The display panel may further include a sealing member S to seal the liquid crystal molecules between the first and second substrates 100 and 200.

For example, the first and second alignment layers 110 and 210 may include the mesogen M, respectively.

The first alignment layer 110 may be disposed on the first substrate 100 and the second aliment layer 210 may be disposed on the second substrate 200.

In an example embodiment, pretilt angles of the first and second alignment layers 110 and 210 are substantially matched to each other. Vertical pretilt angles of the first and the second alignment layers may be within a range of about 1° to about 10°, respectively.

Although the first and second substrates 100 and 200 have a curved shape, the pretilt angles of the first and second alignment layers 110 and 210 are matched such that a transmittance of the display panel increases and a response time decreases.

Hereinafter, a method of a display panel will be mainly explained.

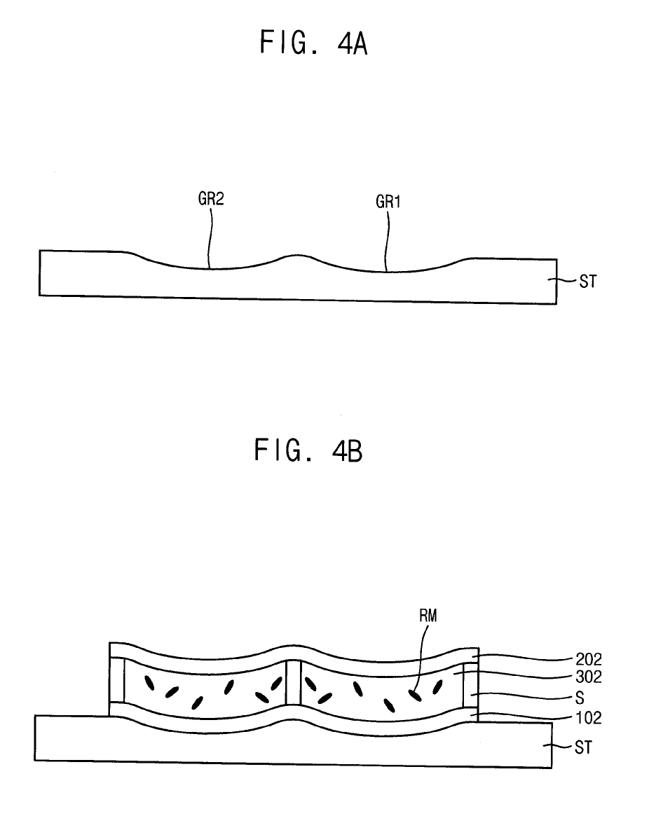

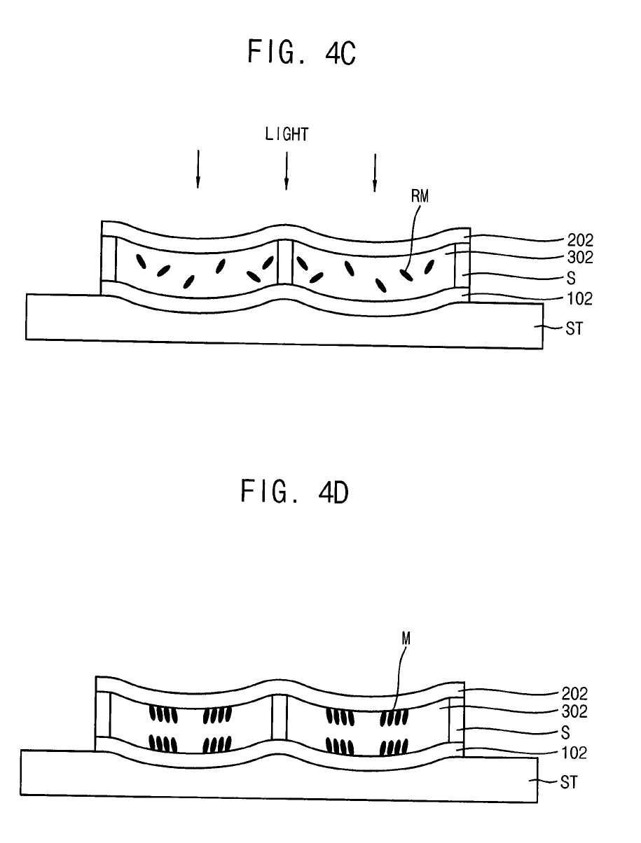

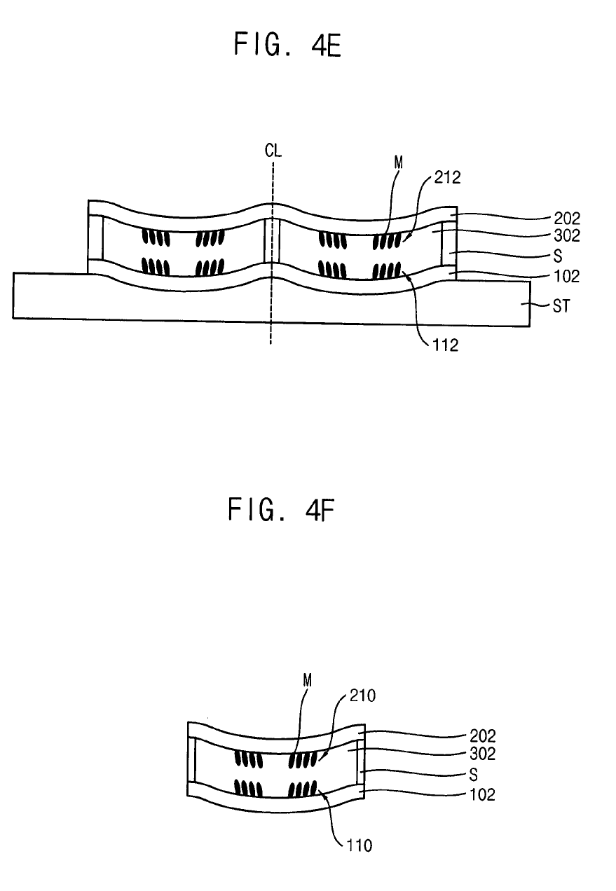

FIGS. 4A to 4F are cross-sectional views for describing a method of manufacturing a display panel according to an example embodiment.

In reference to FIG. 4A, a stage ST on which a plurality of grooves GR1 and GR2 are formed is provided. The grooves GR1 and GR2 may be formed to be horizontally symmetrical to each other.

One groove may be formed on the stage ST to form one display panel, and one groove may correspond to one display panel. A plurality of display panels may be formed by a sawing process.

Referring to FIG. 4B, a first preliminary substrate 102, a second preliminary substrate 202 and a preliminary liquid crystal layer 302 are formed on the stage on which the grooves are formed.

The second preliminary substrate 202 may be disposed to be opposite to the first preliminary substrate 102. For example, the first and second preliminary substrates 102 and 202 may include a glass substrate or a transparent plastic substrate.

The first and second preliminary substrates 102 and 202 may be disposed along a top surface of the stage ST. For example, the first and second preliminary substrates 102 and 202 may have a curved shape according to the grooves GR1 and GR2 on the stages ST.

The preliminary liquid crystal layer 302 may include liquid crystal molecules and reactive mesogen RM. The reactive mesogen RM may be included as about 0.01 weight percent to about 1.0 weight percent over total weight percent of the liquid crystal molecules.

For example the reactive mesogen may include a photoreactive group.

In reference to FIGS. 4C and 4D, the preliminary liquid crystal layer 302 in which an electric field is generated is exposed.

The electric field is generated in the preliminary liquid crystal layer 302 including the reactive mesogen RM. Voltages may be applied to a pixel electrode formed in the first preliminary substrate 102 and a common electrode formed in the second preliminary substrate 202 to generate the electric field. For example, the voltages may be within a range of about 10V to about 30V.

Accordingly, the liquid crystal molecules included in the liquid crystal layer 300 may be tilted to the first and second preliminary substrates 102 and 202 by the voltages. For example, the liquid crystal molecules may be tilted to the first an second preliminary substrates 102 and 202 by about 85° to about 89°.

The preliminary liquid crystal layer 302 may be exposed by ultraviolet rays with an intensity of about more than 10 J/cm².

When the preliminary liquid crystal layer 302 is exposed, reaction between the reactive mesogens RM adjacent to each other in the preliminary liquid crystal layer 302 may occur. The reactive mesogens RM may be bonded to the first and second preliminary substrates 102 and 202. The reactive mesogens RM may be transformed into mesogens M to form first and second preliminary alignment layers 112 and 212 on the first and second preliminary substrates 102 and 202, respectively.

Although not illustrated, after the exposure process, in order to remove a residual reactive mesogen RM, the preliminary liquid crystal layer 302 may be exposed repeatedly without the electric field.

In reference to FIGS. 4E and 4F, a plurality of display panels are formed by a sawing process.

By using a mechanical blade or a laser, the first and second preliminary substrates 102 and 202, the preliminary liquid crystal layer 302 and the sealing member S may be cut along a cutting line CL to form the display panels.

After the sawing process, the first and second preliminary substrates may be transformed into first and second substrates 100 and 200. The first and second preliminary alignment layers 112 and 212 may be transformed into first and second alignment layer 110 and 210. The preliminary liquid crystal layer 302 may be transformed into a liquid crystal layer 300.

In an example embodiment, pretilt angles of the first and second alignment layers 110 and 210 may be substantially matched to each other. For example, vertical pretilt angles of the first and second alignment layers may be within a range of about 1° to about 10°.

Although the first and second substrates 100 and 200 have a curved shape, the pretilt angles of the first and second alignment layers 110 and 210 are matched such that a transmittance of the display panel increases and a response time decreases.

The foregoing is illustrative of example embodiments and is not to be construed as limiting thereof. Although a few example embodiments have been described, those skilled in the art will readily appreciate that many modifications are possible in the example embodiments without materially departing from the novel teachings and advantages of the present inventive concept. Accordingly, all such modifications are intended to be included within the scope of the present inventive concept as defined in the claims. Therefore, it is to be understood that the foregoing is illustrative of various example embodiments and is not to be construed as limited to the specific example embodiments disclosed, and that modifications to the disclosed example embodiments, as well as other example embodiments, are intended to be included within the scope of the appended claims.

What is claimed is:

1. A method of manufacturing an alignment layer, the method comprising:
forming a first substrate, a second substrate opposite to the first substrate and a liquid crystal layer including a reactive mesogen on a stage on which a groove is formed, the liquid crystal layer disposed between the first and second substrates; and
forming the alignment layer by exposing the liquid crystal layer to harden the reactive mesogen.

2. The method of claim 1, wherein forming the alignment layer includes:
forming first and second alignment layers on the first and second substrates, respectively.

3. The method of claim 2, wherein pretilt angles of the first and second alignment layers are substantially matched to each other.

4. The method of claim 1, wherein the reactive mesogen includes a photoreactive group.

5. The method of claim 1, wherein a vertical pretilt angle of the alignment layer is within a range of about 1° to about 10°.

6. The method of claim 1, wherein forming the alignment layer includes:
exposing the liquid crystal layer by using ultraviolet rays.

7. The method of claim 6, wherein the liquid crystal layer is radiated by the ultraviolet rays with an intensity of about more than 10 J/cm².

8. The method of claim 1, wherein forming the alignment layer includes:
exposing the liquid crystal layer in which an electric field is generated by using ultraviolet rays.

9. The method of claim 1, wherein the groove is formed on the stage such that the groove is horizontally symmetrical.

10. The method of claim 1, wherein the first and second substrates are disposed along a top surface of the stage.

11. A method of manufacturing a display panel, the method comprising:
disposing a preliminary display panel including a first substrate, a second substrate opposite to the first substrate and a liquid crystal layer including a reactive mesogen on a stage on which a groove is formed, the liquid crystal layer disposed between the first and second substrates;
forming an alignment layer by exposing the preliminary display panel to harden the reactive mesogen; and
bending the preliminary display panel.

12. The method of claim 11, wherein forming the alignment layer includes:
forming first and second alignment layers on the first and second substrates, respectively.

13. The method of claim 12, wherein pretilt angles of the first and second alignment layers are substantially matched to each other.

14. The method of claim 11, wherein the reactive mesogen includes a photoreactive group.

15. The method of claim 11, wherein a vertical pretilt angle of the alignment layer is within a range of about 1° to about 10°.

16. The method of claim 11, wherein forming the alignment layer includes:
exposing the liquid crystal layer by using ultraviolet rays.

17. The method of claim 16, wherein the liquid crystal layer is radiated by the ultraviolet rays with an intensity of about more than 10 J/cm².

18. The method of claim 11, wherein forming the alignment layer includes:
exposing the liquid crystal layer in which an electric field is generated by using ultraviolet rays.

19. The method of claim 18, wherein the display panel operates in a vertical alignment mode.

20. The method of claim 11, wherein the groove is formed on the stage such that the groove is horizontally symmetrical.
